(19) United States
(12) Patent Application Publication
(10) Pub. No.: US 2011/0317080 A1
(43) Pub. Date: Dec. 29, 2011

(54) LIGHTING DEVICE, DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/255,140

(22) PCT Filed: Dec. 16, 2009
(86) PCT No.: PCT/JP2009/070947

§ 371 Date: Sep. 7, 2011

(30) Foreign Application Priority Data
Mar. 11, 2009 (JP) 2009-57985

(51) Int. Cl. H04N 5/66; F21S 4/00; G02F 1/13357; F21V 7/00

(52) U.S. Cl. 348/739; 362/235; 362/225; 349/62; 348/E05.133

(57) ABSTRACT

A lighting device 12 includes light sources 17, a chassis 14 configured to house the light sources 17 therein and having an opening 14a through which light emitted from the light sources 17 exits and an optical member 15a provided so as to face the light sources 17 and cover the opening 14a. The light sources are arranged parallel to each other in an arrangement direction with having a small interval between some adjacent light sources 17 and having a large interval between some other adjacent light sources 17. The optical member 15a includes a light reflecting portion 31 that reflects light emitted from the light sources 17. The light reflecting portion 31 is provided to change light reflectance in a direction crossing the arrangement direction of the light sources 17.

### TECHNICAL FIELD

The present invention relates to a lighting device, a display device and a television receiver.

### BACKGROUND ART

A liquid crystal panel included in a liquid crystal display device does not emit light, and thus a backlight device is required as a separate lighting device. The backlight device is arranged behind the liquid crystal panel (i.e., on a side opposite from a display surface side). It includes a chassis having an opening on a liquid crystal panel side, a plurality of fluorescent tubes housed in the chassis as a lamp, and an optical member (such as a diffuser plate) that is provided in the opening of the chassis and effectively discharges light emitted from the fluorescent tubes to the liquid crystal panel side.

In such a backlight device where the fluorescent tubes emit linear light, a plurality of fluorescent tubes are aligned with each other and the optical member converts linear light into planer light to unify illumination light. However, if the linear light is not sufficiently converted into the planer light, striped lamp images are generated along the alignment of the fluorescent tubes, and this deteriorates display quality of the liquid crystal display device.

To obtain uniform illumination light from the backlight device, it is desirable to increase the number of lamps and reduce a distance between the adjacent lamps or to increase a diffusion rate of a diffuser plate, for example. However, increase of the number of lamps increases a cost of the backlight device and also increases power consumption. Increase of the diffusion rate of the diffuser plate fails to improve brightness and causes the problem that the number of lamps is required to be increased. A backlight device disclosed in Patent Document 1 has been known as one that suppresses power consumption and ensures uniform brightness.

The backlight device described in Patent Document 1 includes a diffuser plate provided on a rear-surface side of the display panel for exiting diffused light and a number of cold cathode fluorescent lamps that are arranged in parallel to each other. The cold cathode fluorescent lamps are arranged such that arrangement intervals between the cold cathode fluorescent tubes are smaller in a middle area of a display screen of the display panel than in peripheral areas of the display screen. Also, the cold cathode fluorescent lamps are arranged such that a distance between the cold cathode fluorescent lamps and the diffuser plate is smaller in the peripheral areas than the middle area. With such a configuration, sufficient brightness is ensured in the middle area of the display screen and the number of the lamps is reduced in the peripheral areas of the display screen. This suppresses increasing of power consumption.

### PATENT DOCUMENT

[Patent Document 1] Japanese Unexamined Patent Publication No. 2005-347062

### PROBLEM TO BE SOLVED BY THE INVENTION

In the configuration disclosed in Patent Document 1, sufficient brightness is ensured in the middle area of the display screen and the number of the lamps is reduced in the peripheral areas of the display screen, and this may suppress increasing of power consumption. However, a light collection is performed only in the lamp arrangement direction and not performed in the longitudinal direction of the lamp. This fails to ensure sufficient brightness in the middle area of the display screen.

### DISCLOSURE OF THE PRESENT INVENTION

The present invention was made in view of the foregoing circumstances. An object of the present invention is to provide a lighting device that is capable of improving brightness in a certain area such as the middle area of the display screen by effectively using light emitted from the light source. Another object of the present invention is to provide a display device including such a lighting device and provide a television receiver including such a display device.

### MEANS FOR SOLVING THE PROBLEM

To solve the above problem, a lighting device of the present invention includes light sources, a chassis configured to house the light sources therein and having an opening through which light emitted from the light sources exits, and an optical member provided so as to face the light sources and cover the opening. The light sources are arranged parallel to each other in an arrangement direction with having a small interval between some adjacent light sources and having a large interval between some other adjacent light sources. A light reflecting portion is provided on the optical member and configured to reflect light emitted from the light sources and change light reflectance in a direction crossing the arrangement direction of the light sources.

In such a lighting device, the light sources are arranged parallel to each other with having a large interval between some light sources and having a small interval between some other light sources. Rays of light are collected effectively in the arrangement direction depending on the size of intervals between the light sources. Also, the light reflecting portion is provided on the optical member such that light reflectance changes in a direction crossing the arrangement direction. This enables the light collection in the direction crossing the arrangement direction. Therefore, sufficient brightness is ensured in a certain portion such as the middle portion according to a combination of the intervals of the light sources and the light reflectance change (distribution) of the light reflecting portion.

The light collection in a direction crossing the arrangement direction made by light reflection is less likely to cause re-absorption of the rays of reflected light by the light sources compared to the light collection in the arrangement direction.

### BRIEF DESCRIPTION OF THE DRAWINGS

FIG. 1 is an exploded perspective view illustrating a general construction of a television receiver according to the present invention;

FIG. 2 is an exploded perspective view illustrating a general construction of a liquid crystal display device provided in the television receiver;

FIG. 3 is a cross-sectional view of the liquid crystal display device along the short-side direction;

FIG. 4 is a cross-sectional view of the liquid crystal display device along the long-side direction;

FIG. 5 is a plan view illustrating an arrangement of cold cathode tubes and a chassis provided in the liquid crystal display device;

FIG. 6 is a partially-enlarged plan view illustrating a general construction of a second surface of a light guide plate provided in the liquid crystal display device;

FIG. 7 is a plan view explaining a light reflectance distribution on the second surface of the light guide plate;

FIG. 8 is a graph illustrating a light reflectance change in the short-side direction of the light guide plate;

FIG. 9 is a cross-sectional view illustrating an arrangement pattern of light reflecting portion formed on the light guide plate;

FIG. 10 is a graph illustrating a light reflectance change in the light guide plate according to one modification;

FIG. 11 is a graph illustrating a light reflectance change in the light guide plate according to another modification;

FIG. 12 is a cross-sectional view illustrating a light reflecting portion formed on a light guide plate according to a first modification;

FIG. 13 is a cross-sectional view illustrating a light reflecting portion formed on a light guide plate according to a second modification;

FIG. 14 is a cross-sectional view illustrating a light reflecting portion formed on a light guide plate according to a third modification;

FIG. 15 is a cross-sectional view illustrating a light reflecting portion formed on a light guide plate according to a fourth modification;

FIG. 16 is a cross-sectional view illustrating a light reflecting portion formed on a light guide plate according to a fifth modification;

FIG. 17 is a cross-sectional view illustrating a light reflecting portion formed on a light guide plate according to a sixth modification;

FIG. 18 is a cross-sectional view illustrating a light reflecting portion formed on a light guide plate according to a seventh modification;

FIG. 19 is a cross-sectional view illustrating a light reflecting portion formed on a light guide plate according to an eighth modification;

FIG. 20 is a cross-sectional view illustrating a light reflecting portion formed on a light guide plate according to a ninth modification;

FIG. 21 is a plan view illustrating a light reflecting portion formed on a light guide plate according to a tenth modification and explaining a light reflectance distribution; and

FIG. 22 is an enlarged plan view partially illustrating a light reflecting portion formed on a light guide plate according to an eleventh modification.

### BEST MODE FOR CARRYING OUT THE INVENTION

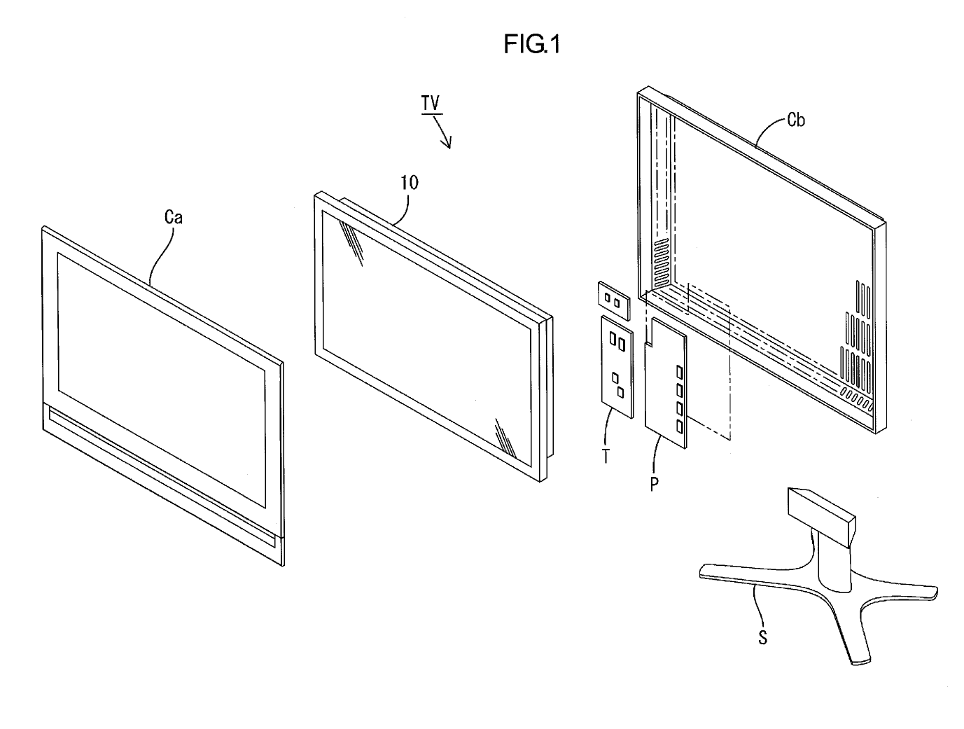

An embodiment of the present invention will be explained with reference to FIGS. 1 to 9.

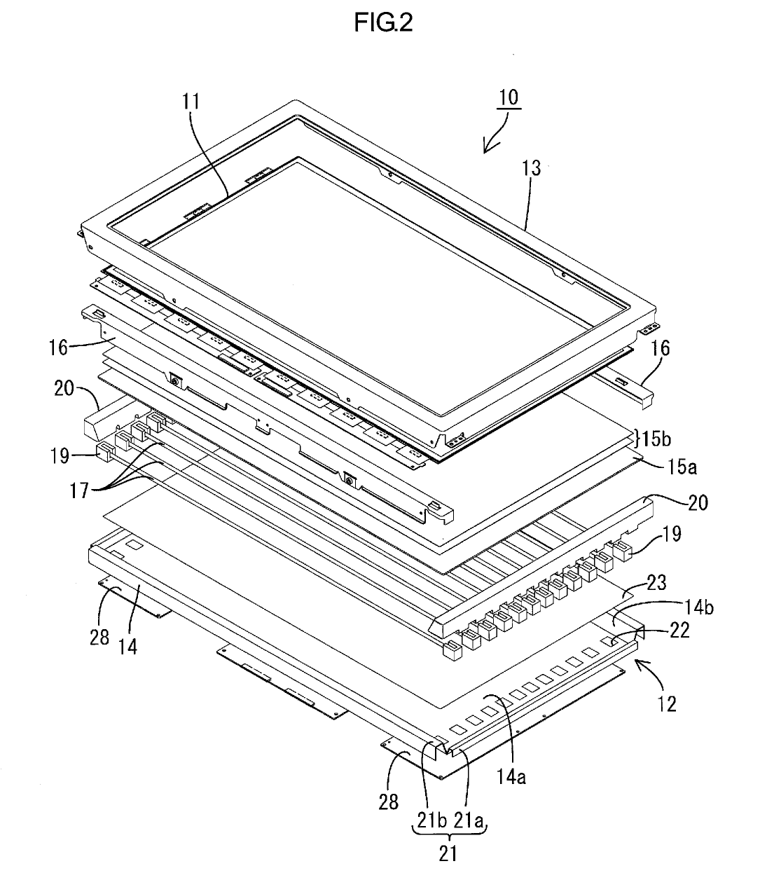

First, a construction of a television receiver TV including a liquid crystal display device 10 will be explained. As illustrated in FIG. 1, the television receiver TV includes the liquid crystal display device 10, front and rear cabinets Ca, Cb that house the liquid crystal display device 10 therebetween, a power source P, a tuner T and a stand S. An overall shape of the liquid crystal display device (display device) 10 is a landscape rectangular. The liquid crystal display device 10 is housed in a vertical position such that a short-side direction thereof matches a vertical line. As illustrated in FIG. 2, it includes a liquid crystal panel 11 as a display panel, and a backlight device 12 (lighting device), which is an external light source. They are integrally held by a bezel 13 and the like.

Next, the liquid crystal panel 11 and the backlight device 12 included in the liquid crystal display device 10 will be explained (see FIGS. 2 to 4).

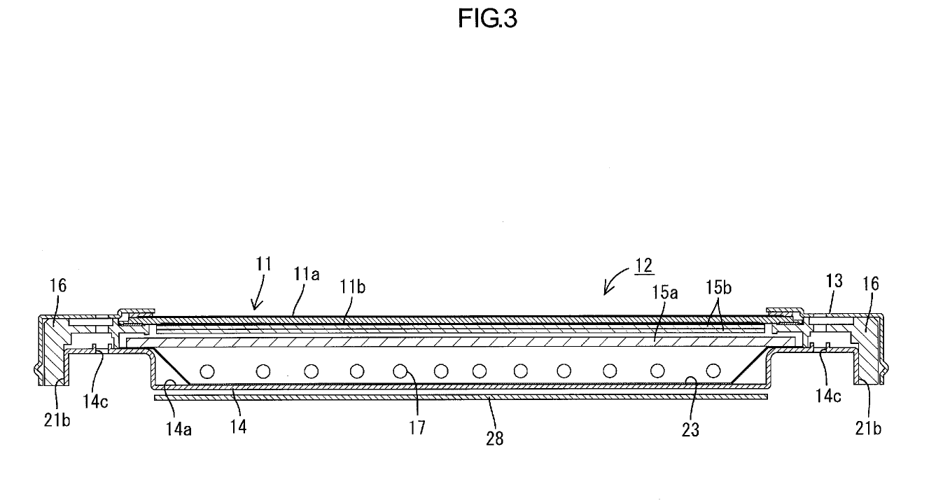

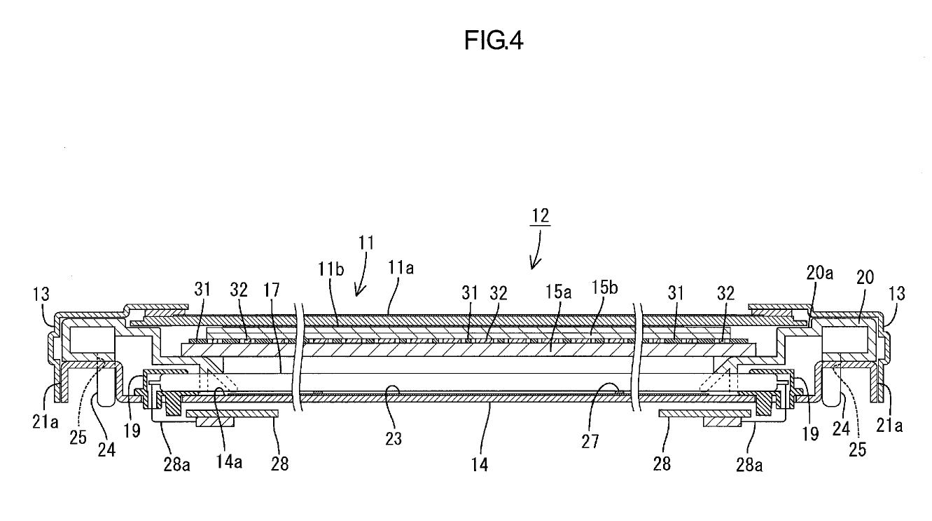

The liquid crystal panel (display panel) 11 is constructed such that a pair of glass substrates is bonded together with a predetermined gap therebetween and liquid crystal is sealed between the glass substrates. On one of the glass substrates, switching components (e.g., TFTs) connected to source lines and gate lines that are perpendicular to each other, pixel electrodes connected to the switching components, and an alignment film are provided. On the other substrate, a color filter having color sections such as R (red), G (green) and B (blue) color sections arranged in a predetermined pattern, counter electrodes, and an alignment film are provided. Polarizing plates 11a, 11b are attached to outer surfaces of the substrates (see FIGS. 3 and 4).

As illustrated in FIG. 2, the backlight device 12 includes a chassis 14, an optical sheet set 15 provided to cover the opening 14b of the chassis 14 (light guide plate (optical member) 15a and a plurality of optical sheets (light scattering members) 15b that are disposed between the light guide plate 15a and the liquid crystal panel 11), and frames 16. The chassis 14 has a substantially box-shape and an opening 14b on the light output side (on the liquid crystal panel 11 side). The frames 16 arranged along the long sides of the chassis 14 hold the long-side edges of the diffuser plate 15a to the chassis 14. The long-side edges of the diffuser plate 15a are sandwiched between the chassis 14 and the frames 16. Cold cathode tubes (light sources) 17, lamp clips 18 (not illustrate), relay connectors 19 and lamp holders 20 are installed in the chassis 14. The lamp clips 18 are provided for mounting the cold cathode tube 17 to the chassis 14. The relay connectors 19 are connected to ends of the cold cathode tubes 17 for making electrical connection. The lamp holders 20 collectively cover ends of the cold cathode tubes 17 and the relay connectors 19. A light output side of the backlight device 12 is a side closer to the light guide plate 15a than the cold cathode tubes 17.

The chassis 14 is prepared by processing a metal plate. The chassis 14 is formed in a substantially shallow box shape as illustrated in FIGS. 3 and 4. It includes a rectangular bottom plate 14a and outer rims 21, each of which extends upright from the corresponding side of the bottom plate 14a and has a substantially U shape. The outer rims 21 include short-side outer rims 21a and long-side outer rims 21b provided at the short sides and the long sides of the chassis 14, respectively. The bottom plate 14a has a plurality of mounting holes 22 along the long-side edges thereof. The relay connectors 19 are mounted in the mounting holes 22. As illustrated in FIG. 3, fixing holes 14c are provided on the upper surface of the chassis 14 along the long-side outer rims 21b to bind the bezel 13, the frames 16 and the chassis 14 together with screws and the like.

A light reflecting sheet 23 is disposed on an inner surface of the bottom plate 14a of the chassis 14 (on a side that faces the cold cathode tubes 17). The light reflecting sheet 23 is a synthetic resin sheet having a surface in white color that provides high light reflectance. It is placed so as to cover almost entire inner surface of the bottom plate 14a of the chassis 14. As illustrated in FIG. 3, long-side edges of the light reflecting sheet 23 are lifted so as to cover the long-side outer rims 21b of the chassis 14 and sandwiched between the chassis 14 and the diffuser plate 15. With this light reflecting sheet 23, light emitted from the cold cathode tubes 17 is reflected to the diffuser plate 15.

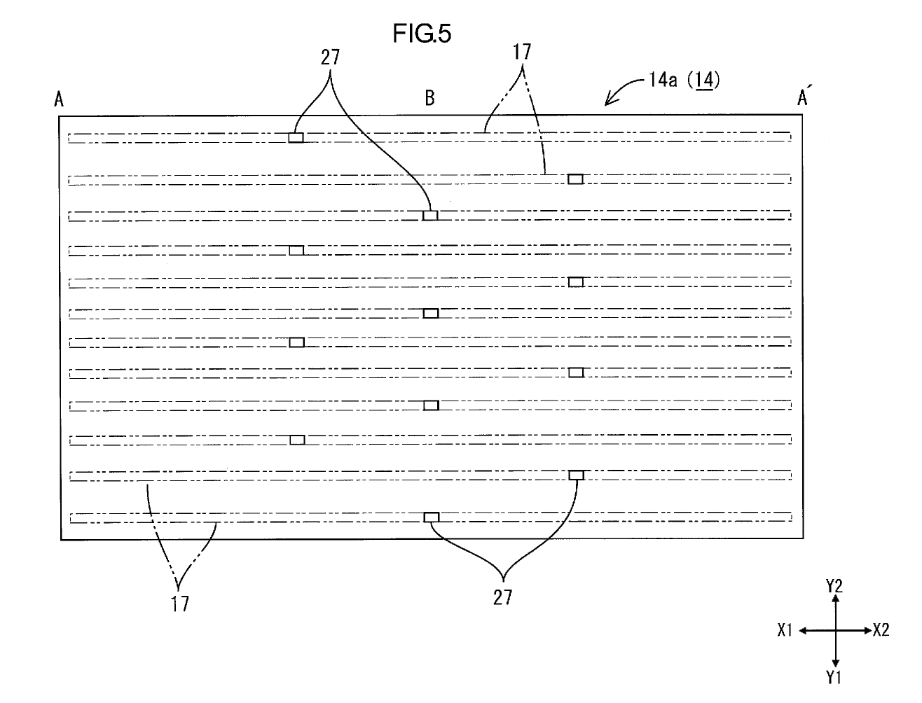

Each cold cathode tube 17 has an elongated tubular shape. As illustrated in FIG. 5, a plurality of the cold cathode tubes 17 are installed in the chassis 14 so as to be parallel to each other. The cold cathode tubes 17 are arranged such that they are arranged parallel to each other with the long-side direction (axial direction) thereof aligned along the long-side direction of the chassis 14. The cold cathode tubes 17 are arranged on an entire surface (an entire area) of the bottom plate 14a of the chassis 14. The cold cathode tubes 17 are arranged to be parallel to each other at small intervals between some adjacent cold cathode tubes 17 and at large intervals between some other adjacent cold cathode tubes 17. Specifically, in an area in which the cold cathode tubes 17 are arranged (in a surface area of the chassis 14), the intervals between the adjacent cold cathode tubes 17 are relatively large at the end sides in the arrangement direction of the cold cathode tubes 17. In an area in which the cold cathode tubes 17 are arranged (in a surface area of the chassis 14), the intervals between the adjacent cold cathode tubes 17 are relatively small in a middle area in the arrangement direction of the cold cathode tubes 17. Thus, the cold cathode tubes 17 are arranged at irregular arrangement intervals.

The cold cathode tubes 17 are held by the lamp clips 18 (not illustrated) so as to be supported with a small gap between the cold cathode tubes 17 and the bottom plate 14a of the chassis 14 (reflecting sheet 23) (see FIG. 4). Heat transfer members 27 are disposed in the gap so as to be in contact with a part of the cold cathode tube 17 and the bottom plate 14a (reflecting sheet 23).

Each heat transfer member 27 has a form of a rectangular plate and as illustrated in FIG. 5, each heat transfer member 27 is disposed just under each cold cathode tube 17 such that its longitudinal direction matches an axial direction of the cold cathode tubes 17. When the cold cathode tubes 17 are lit, at the portions where the heat transfer members 27 are disposed, heat can be transferred from the cold cathode tubes 17 having high temperature to the bottom plate 30 of the chassis 14 via the heat transfer members 27. Therefore, the temperature is lowered at the portions of the cold cathode tubes 17 that are in contact with the heat transfer members 27, and the coldest point is forcibly generated at the portions of the cold cathode tubes where the heat transfer members 27 are disposed.

The heat transfer members 27 are arranged in staggered layout on the bottom plate 14a of the chassis 14. That is, one heat transfer member 27 and its adjacent heat transfer members 27, 27 are offset from each other in an arrangement direction (the short-side direction of the bottom plate 14a) of the cold cathode tubes 17. Namely, the one and the adjacent heat transfer members are not aligned along a line.

The holders 20 that cover the ends of the cold cathode tubes 17 and the relay connectors 19 are made of white synthetic resin. Each of them has an elongated substantially box shape that extends along the short side of the chassis 14 as illustrated in FIG. 2. As illustrated in FIG. 4, each holder 20 has steps on the front side such that the light guide plate 15a and the liquid crystal panel 11 are held at different levels. A part of the holder 20 is placed on top of apart of the corresponding short-side outer rim 21a of the chassis 14 and forms a side wall of the backlight device 12 together with the short-side outer rim 21a. An insertion pin 24 projects from a surface of the holder 20 that faces the outer rim 21a of the chassis 14. The holder 20 is mounted to the chassis 14 by inserting the insertion pin 24 into the insertion hole 25 provided in the top surface of the short-side outer rim 21a of the chassis 14.

On the outer surface of the bottom plate 14a of the chassis 14 (on a side opposite from the cold cathode tubes 17), as illustrated in FIGS. 3 and 4, the inverter board set (light source driving board) 28 is provided so as to overlap ends of the cold cathode tubes 17. Accordingly, drive power is supplied from the inverter board set 28 to the cold cathode tubes 17. Each end of each cold cathode tube 17 has a terminal (not shown) for receiving drive power and electrical connection between the terminal and a harness 28a (see FIG. 4) derived from the inverter board set 28 enables supply of high-voltage drive power. Such electrical connection is established in a relay connector 19 in which the end of the cold cathode tube 17 is fitted. The holders 20 are mounted so as to cover the relay connectors 19.

On the opening 14b side of the chassis 14, the optical sheet set 15 including the light guide plate (the optical member) 15a and the optical sheet (the light scattering member) 15b is provided. The light guide plate 15a guides light emitted from the cold cathode tubes 17 to the optical sheet 15b side. The short-side edges of the light guide plate 15a are placed on the first surface 20a of the holder 20 as described above, and does not receive a vertical force. As illustrated in FIG. 3, the long-side edges of the light guide plate 15a are sandwiched between the chassis 14 (the reflecting sheet 23) and the frame 16. Accordingly, the light guide plate 15a covers the opening 14b of the chassis 14.

The optical sheets 15b provided on the light guide plate 15a include layered two diffuser sheets. The optical sheets 15b convert light emitted from the cold cathode tubes 17 passing through the light guide plate 15a into planer light. The liquid crystal display panel 11 is disposed on the top surface of the top layer of the optical sheets 15b. The optical sheets 15b are held between the light guide plate 15a and the liquid crystal panel 11.

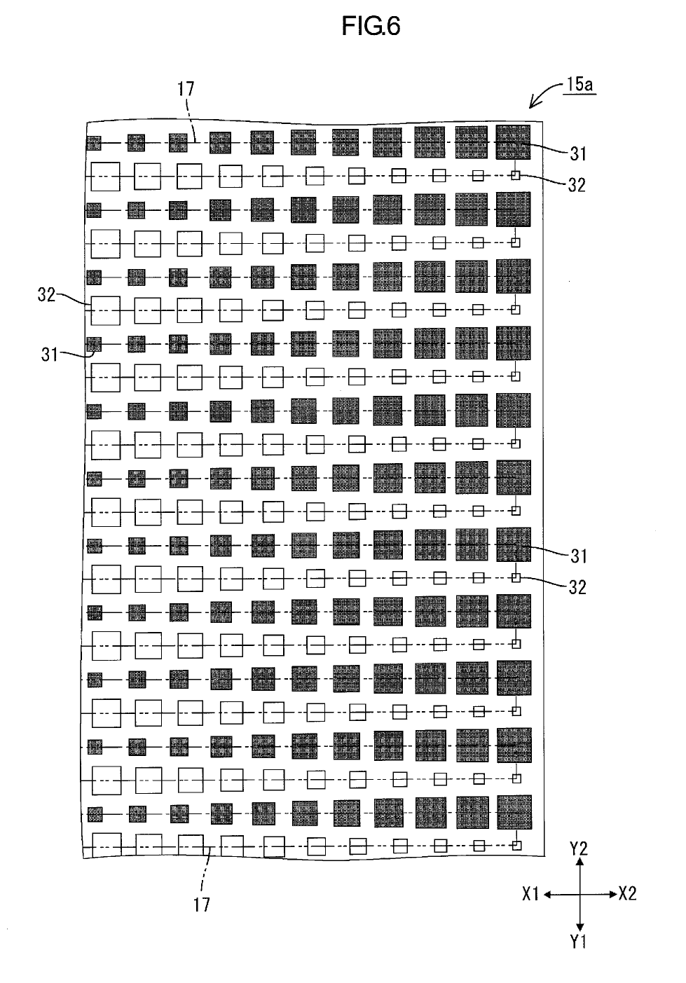

A configuration of the light guide plate 15a will be explained with reference to FIGS. 6 to 9.

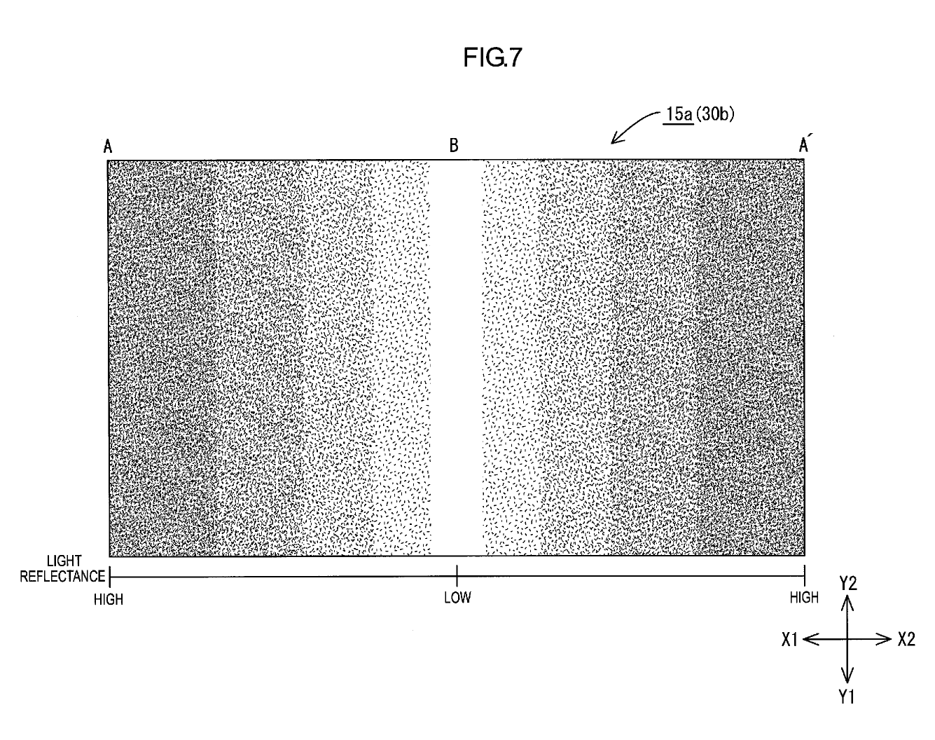

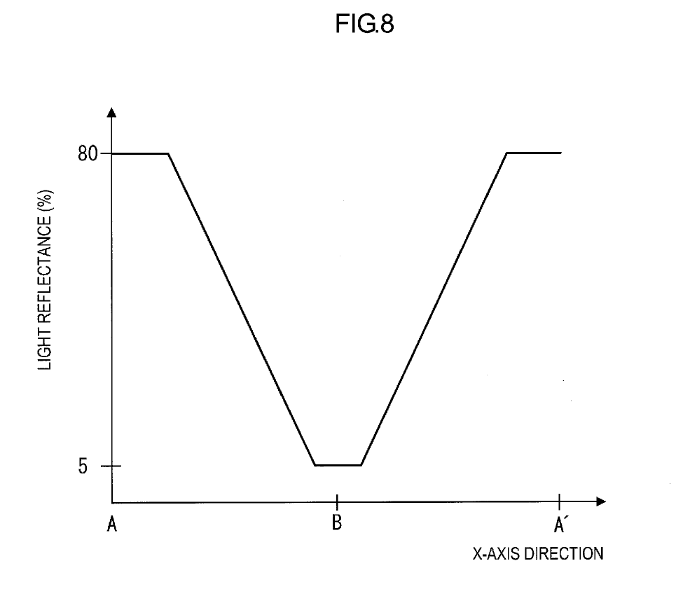

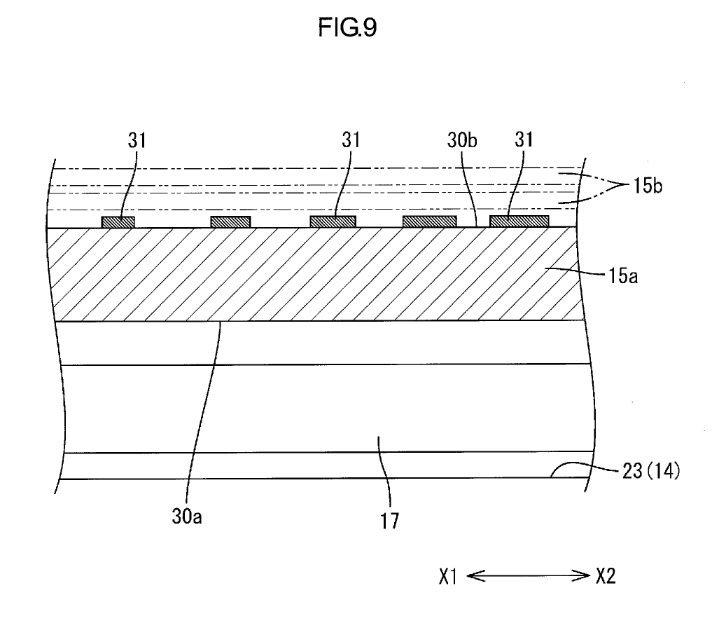

FIG. 6 is a partially-enlarged plan view illustrating a general construction of a second surface 30b of the light guide plate 15a facing the optical sheet 15b. FIG. 7 is a plan view explaining a light reflectance distribution on the second surface 30b of the light guide plate 15a. FIG. 8 is a graph illustrating a light reflectance change in the short-side direction of the light guide plate. FIG. 9 is a cross-sectional view illustrating an arrangement pattern of light reflecting portion 31 formed on the light guide plate 15a. In FIGS. 6 to 9, the long-side direction of the light guide plate is referred to as an X-axis direction and the short-side direction thereof is referred to as a Y-axis direction. In FIG. 8, a horizontal axis shows the Y-axis direction (short-side direction) and the light reflectance obtained from a point A to a point B of the Y-axis direction and from the point B to a point A′ of the Y-axis direction is plotted on a graph.

The light guide plate 15a is formed of organic high molecule preferably selected from polymethylmethacrylate, methacylate styrene and polycarbonate. The light guide plate 15a is a plate member having a substantially uniform light transmittance over an entire area (an entire area is substantially transparent). The light guide plate 15a has a surface facing the cold cathode tubes 17 (first surface 30a) and a surface facing the optical sheets 15b (second surface 30b) that is positioned opposite from the first surface 30a. As illustrated in FIG. 6, light reflecting portion 31 and light scattering portion 32 that have a dot pattern are formed on the second surface 30b of the light guide plate 15a. The dot pattern forming the light reflecting portion 31 and the light scattering portion 32 is formed by printing paste containing inorganic beads, for example, on the second surface 30b of the light guide plate 15a. Preferable printing means is serigraph, inkjet printing, screen printing and the like.

The light reflecting portion 31 has a light reflectance of 80% and the light guide plate 15a facing the cold cathode tube 17 has a light reflectance of 5% in its surface area. Thus, the light reflecting portion 31 has a high light reflectance. In the present embodiment, the light reflectance of each material is represented by an average light reflectance measured with a LAV of CM-3700d (measurement area diameter of 25.4 mm) manufactured by Konica Minolta inside the measurement circle. The light reflectance of the light reflecting portion 31 is measured in the following method. The light reflecting portion 31 is formed over an entire surface of a glass substrate and the light reflectance of the surface is measured according to the above measurement means. The light reflectance of the light reflecting portion 31 is preferably 80% or more, and more preferably 90% or more. Thus, as the light reflectance of the light reflecting portion 31 is higher, the light reflection is controlled more precisely and accurately according to a pattern form of the dot pattern such as the number of dots or the area of each dot.

The light reflecting portion 31 is formed by arranging a plurality of square dots on the second surface 30b. Inorganic beads each having a diameter of approximately several hundreds μm are dispersed in each dot and each dot has a surface in white color that provides high light reflectance. The light reflecting portion 31 is formed on the second surface 30b of the light guide plate 15a such that the light reflectance changes in a direction (the X-axis direction) crossing (perpendicular to) the arrangement direction (the Y-axis direction) of the cold cathode tubes 17. The area of each dot continuously reduces from the end to the middle portion in the longitudinal direction (the X-axis direction) of the light guide plate 15a. Namely, the light reflectance continuously changes in the longitudinal direction of the light guide plate 15a having a rectangular shape with plan view (see FIG. 8). The light reflectance is maximum at the ends (the point A and the point A′) of the light guide plate 15a and minimum in the middle portion (the point B) of the light guide plate 15a. The light reflecting portion 31 is formed such that the light reflectance is uniform in the arrangement direction (the Y-axis direction) of the cold cathode tubes 17. Namely, the light reflectance distribution is substantially uniform in the Y-axis direction on the light guide plate 15a.

Thus, the light reflectance of the second surface 30b of the light guide plate 15a is changed by changing the area occupied by the dots (dot pattern) of the light reflecting portion 31. The light reflectance of the light reflecting portion 31 is higher than that of the second surface 30b of the light guide plate 15a. Therefore, the light reflectance becomes relatively higher by relatively increasing the area occupied by the dots of the light reflecting portion 31, and the light reflectance becomes relatively lower by decreasing the area occupied by the dots of the light reflecting portion 31.

The light scattering portion 32 is formed by arranging a plurality of square dots in a predetermined pattern as illustrated in FIG. 6. Inorganic beads each having a diameter of approximately from several nm to several hundreds nm are dispersed in each dot and each dot has good light scattering property and is visible as a dark point. The light scattering portion 32 is formed on the second surface 30b of the light guide plate 15a such that the light reflectance changes in a direction (the X-axis direction) crossing the arrangement direction (the Y-axis direction) of the cold cathode tubes 17. The area of each dot continuously increases from the end to the middle portion in the longitudinal direction (the X-axis direction) of the light guide plate 15a. The changing pattern of the dot areas of the dot pattern of the light scattering portion 32 is reverse to that of the light reflecting portion 31.

The lighting device 12 of the liquid crystal display device 10 included in the television receiver TV is configured such that the cold cathode tubes 17 are arranged parallel to each other with having a large interval between some cold cathode tubes 17 and having a small interval between some other cold cathode tubes 17. Rays of light are collected effectively in the arrangement direction of the cold cathode tubes 17 depending on the size of intervals between the cold cathode tubes 17. Also, the light reflecting portion 31 is provided on the light guide plate (the optical member) 15a such that the light reflectance changes in a direction crossing the arrangement direction of the cold cathode tubes 17. This enables the light collection in the direction crossing the arrangement direction. Therefore, sufficient brightness is ensured in a certain portion such as the middle portion in the present embodiment according to a combination of the intervals of the cold cathode tubes 17 and the light reflectance change (distribution) of the light reflecting portion 31.

In the present embodiment, in an area where the cold cathode tubes 17 are arranged, an interval between the adjacent cold cathode tubes 17 is relatively large at the end in the arrangement direction of the cold cathode tubes 17, and an interval between the adjacent cold cathode tubes is relatively small in the middle portion of the arrangement direction of the cold cathode tubes 17. This enables the light collection in the middle portion in the arrangement direction of the cold cathode tubes 17 and sufficient brightness is ensured in the middle portion.

In the present embodiment, the light reflecting portion 31 is formed such that the light reflectance is relatively high at the ends (the points A, A′) of the light guide plate 15a in the direction crossing the arrangement direction of the cold cathode tubes 17 and the light reflectance is relatively low in the middle portion (the point B) in the direction crossing the arrangement direction of the cold cathode tubes 17. This enables the light collection in the middle portion (the point B) in the direction crossing the arrangement direction of the cold cathode tubes 17 and sufficient brightness is ensured in the middle portion (the point B).

In the present embodiment, the light reflecting portion 31 is formed in a dot pattern having light reflectance. Thus, the light reflection is controlled by a pattern form of the dot pattern. Accordingly, uniform illumination brightness can be easily obtained. In the present embodiment, the area of each dot becomes smaller from a portion having high light reflectance to a portion having low light reflectance. This achieves light reflectance change simply and surely.

In the present embodiment, the light reflectance is uniform in the arrangement direction of the cold cathode tubes 17. Therefore, the rays of light are collected in the arrangement direction depending on the size of intervals between the cold cathode tubes 17. The light collection in the arrangement direction is not related to an area of each dot of the light reflecting portion 31.

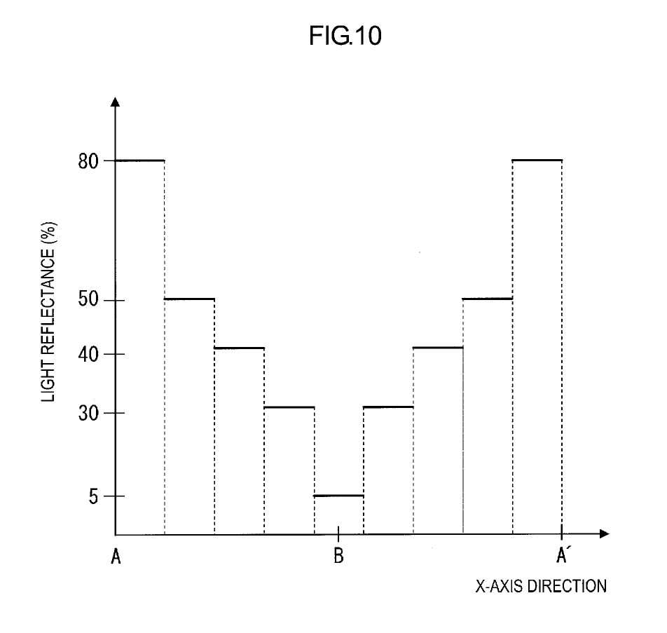

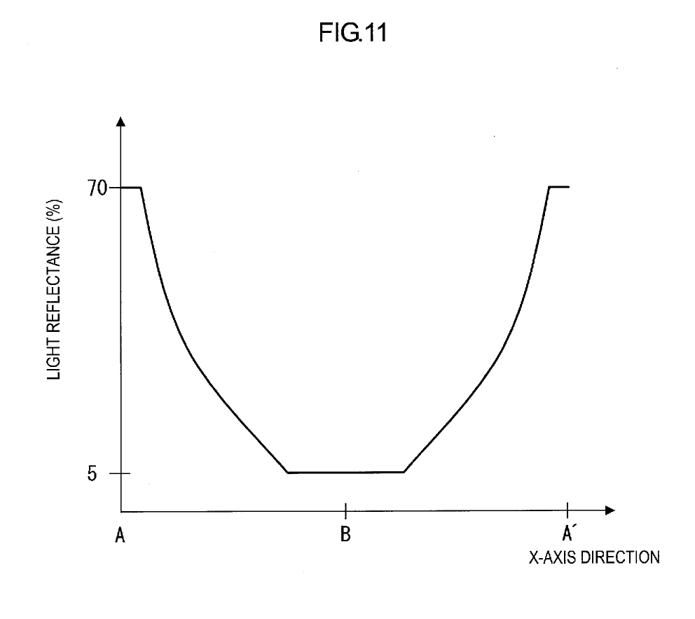

In the present embodiment, the light reflecting portion 31 is formed such that the light reflectance reduces in a continuous and gradual manner from the portion having high light reflectance to the portion having low light reflectance. For example, as illustrated in FIG. 10, the light reflecting portion 31 may be formed such that the light reflectance reduces in a stepwise manner from the portion having high light reflectance to the portion having low light reflectance. Further, as illustrated in FIG. 11, the light reflecting portion 31 may be formed such that the light reflectance is 70% at the ends (the points A, A′) in the X-axis direction and reduces to the middle portion (the point B) in a continuous and quadratic function manner.

The present invention is not limited to the above embodiment, and may include following modifications for example. In the following modifications, the same parts as the above embodiment are indicated by the same symbols and will not be illustrated and explained.

### First Modification

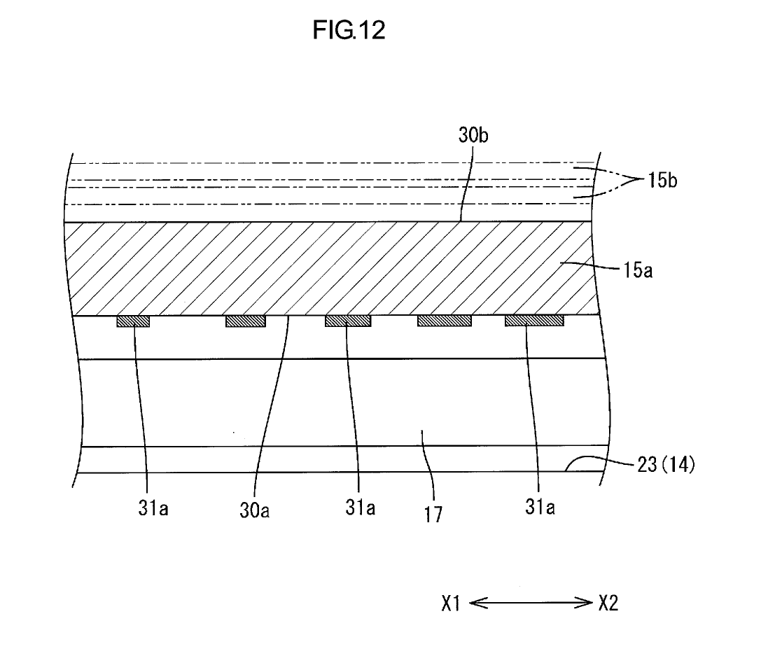

A light reflecting portion formed on a light guide plate according to a first modification will be explained with reference to FIG. 12. In the above embodiment, the light reflecting portion 31 of a dot pattern is formed on the second surface 30b of the light guide plate 15a. As illustrated in FIG. 12, a light reflecting portion 31a of a similar dot pattern may be formed on a first surface 30a of the light guide plate 15a. The light reflecting portion 31a is formed by printing a paste including inorganic beads therein on the first surface 30a of the light guide plate 15a.

The light reflecting portion 31a is formed by arranging a plurality of square dots on the first surface 30a like the light reflecting portion 31 of the above embodiment. Inorganic beads each having a diameter of approximately several hundreds μm are dispersed in each dot and each dot has a surface in white color that provides high light reflectance. The light reflecting portion 31a is formed on the first surface 30a of the light guide plate 15a such that the light reflectance changes in a direction (the X-axis direction) crossing the arrangement direction (the Y-axis direction) of the cold cathode tubes 17. The area of each dot continuously reduces from the end to the middle portion in the longitudinal direction (the X-axis direction) of the light guide plate 15a. Namely, the light reflectance continuously changes in the longitudinal direction of the light guide plate 15a having a rectangular shape with plan view (see FIG. 8). The light reflectance is maximum at the ends (the point A and the point A′) of the light guide plate 15a and minimum in the middle portion (the point B) of the light guide plate 15a. The light reflecting portion 31a is formed such that the light reflectance is uniform in the arrangement direction (the Y-axis direction) of the cold cathode tubes 17. Namely, the light reflectance distribution is substantially uniform in the Y-axis direction on the light guide plate 15a.

### Second Modification

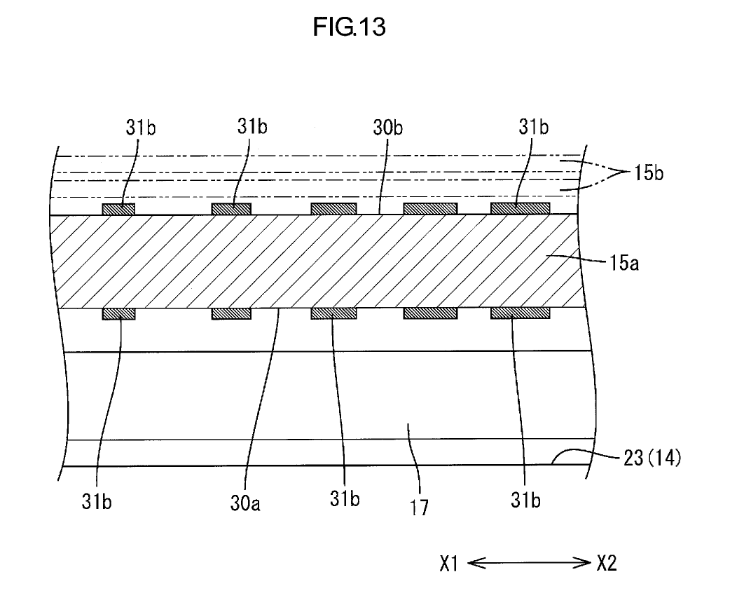

Next, a light reflecting portion formed on a light guide plate according to a second modification will be explained with reference to FIG. 13. In the above embodiment, the light reflecting portion 31 of a dot pattern is formed on the second surface 30b of the light guide plate 15a. As illustrated in FIG. 13, a light reflecting portion 31b of a similar dot pattern may be formed on the first surface 30a and the second surface 30b of the light guide plate 15a. The light reflecting portion 31b is formed by printing a paste including inorganic beads therein on the first surface 30a and the second surface 30b of the light guide plate 15a.

The light reflecting portion 31b is formed by arranging a plurality of square dots on the first surface 30a and the second surface 30b like the light reflecting portion 31 of the above embodiment. Inorganic beads each having a diameter of approximately several hundreds μm are dispersed in each dot and each dot has a surface in white color that provides high light reflectance. The light reflecting portion 31b is formed on the first surface 30a and the second surface 30b of the light guide plate 15a such that the light reflectance changes in a direction (the X-axis direction) crossing the arrangement direction (the Y-axis direction) of the cold cathode tubes 17. The area of each dot continuously reduces from the end to the middle portion in the longitudinal direction (the X-axis direction) of the light guide plate 15a. Namely, the light reflectance continuously changes in the longitudinal direction of the light guide plate 15a having a rectangular shape with plan view (see FIG. 8). The light reflectance is maximum at the ends (the point A and the point A′) of the light guide plate 15a and minimum at the middle portion (the point B) of the light guide plate 15a. The light reflecting portion 31b is formed such that the light reflectance is uniform in the arrangement direction (the Y-axis direction) of the cold cathode tubes 17. Namely, the light reflectance distribution is substantially uniform in the Y-axis direction on the light guide plate 15a.

### Third Modification

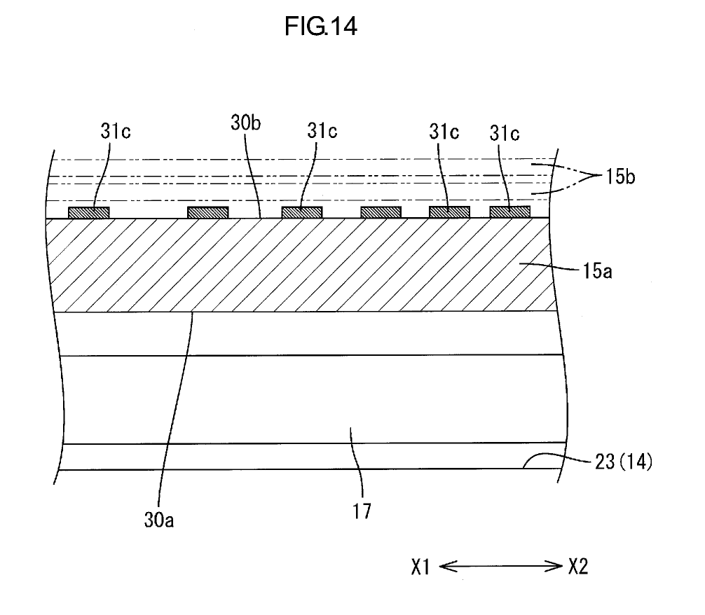

Next, a light reflecting portion formed on a light guide plate according to a third modification will be explained with reference to FIG. 14. In the above embodiment, the light reflectance of the second surface 30b of the light guide plate 15a is changed by changing an area of the dot pattern of the light reflecting portion 31. As illustrated in FIG. 14, the light reflecting portion 31c is formed on the second surface 30b such that an area of each dot of the dot pattern is same and the number of dots in a unit area (density) is changed to change the light reflectance of the second surface 30b of the light guide plate 15a. In FIG. 14, the dots are formed on only the second surface 30b. However, like the first and second modifications, the light reflecting portion 30c may be formed on the first surface 30a in a similar pattern.

Like the above embodiment, the light reflecting portion 31c is formed by printing a paste including inorganic beads on the second surface 30b of the light guide plate 15a.

The light reflecting portion 31c is formed by arranging a plurality of square dots on the second surface 30b like the light reflecting portion 31 of the above embodiment. Inorganic beads each having a diameter of approximately several hundreds μm are dispersed in each dot and each dot has a surface in white color that provides high light reflectance. The light reflecting portion 31c is formed on the second surface 30b of the light guide plate 15a such that the light reflectance changes in a direction (the X-axis direction) crossing the arrangement direction (the Y-axis direction) of the cold cathode tubes 17. The density of dots continuously reduces from the end to the middle portion in the longitudinal direction (the X-axis direction) of the light guide plate 15a. Namely, the light reflectance continuously changes in the longitudinal direction of the light guide plate 15a having a rectangular shape with plan view (see FIG. 8). The light reflectance is maximum at the ends (the point A and the point A′) of the light guide plate 15a and minimum at the middle portion (the point B) of the light guide plate 15a. The light reflecting portion 31c is formed such that the light reflectance is uniform in the arrangement direction (the Y-axis direction) of the cold cathode tubes 17. Namely, the light reflectance distribution is substantially uniform in the Y-axis direction on the light guide plate 15a.

### Fourth Modification

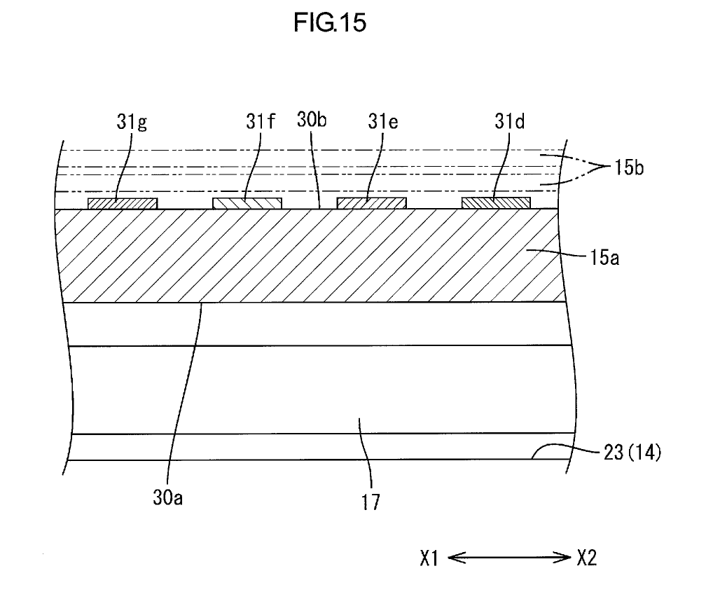

Next, a light reflecting portion formed on a light guide plate according to a fourth modification will be explained with reference to FIG. 15. In the above embodiment, the light reflectance of the second surface 30b of the light guide plate 15a is changed by changing a dot area of the dot pattern of the light reflecting portion 31. As illustrated in FIG. 15, dots 31d, 31e, 31f, 31g . . . each of which has a same area and has different light reflectance are formed on the second surface 30b. Accordingly, the light reflectance of the second surface 30b of the light guide plate 15a is changed. In FIG. 15, the dots are formed on only the second surface 30b. As mentioned in the first and second modifications, the dots 31d, 31e, 31f, 31g . . . may be formed on the first surface 30a in a similar pattern.

Like the above embodiment, the dots 31d, 31e, 31f, 31g . . . are formed by printing a paste including inorganic beads on the second surface 30b of the light guide plate 15a.

The dots 31d, 31e, 31f, 31g . . . are formed by arranging a plurality of square dots on the second surface 30b like the light reflecting portion 31 of the above embodiment. Inorganic beads each having a diameter of approximately several hundreds μm are dispersed in each dot and each dot has a surface in white color that provides high light reflectance. The dots 31d, 31e, 31f, 31g . . . are formed on the second surface 30b of the light guide plate 15a such that the light reflectance changes in a direction (the X-axis direction) crossing the arrangement direction (the Y-axis direction) of the cold cathode tubes 17. The light reflectance of each dot continuously reduces from the end to the middle portion in the longitudinal direction (the X-axis direction) of the light guide plate 15a. The light reflectance reduces from the dot 31d, 31e, 31f, 31g in this order. As a result, the light reflectance continuously changes in the longitudinal direction of the light guide plate 15a having a rectangular shape with plan view (see FIG. 8). The light reflectance is maximum at the ends (the point A and the point A′) of the light guide plate 15a and minimum at the middle portion (the point B) of the light guide plate 15a. The dots 31d, 31e, 31f, 31g . . . are formed such that the light reflectance is uniform in the arrangement direction (the Y-axis direction) of the cold cathode tubes 17. Namely, the light reflectance distribution is substantially uniform in the Y-axis direction on the light guide plate 15a.

### Fifth Modification

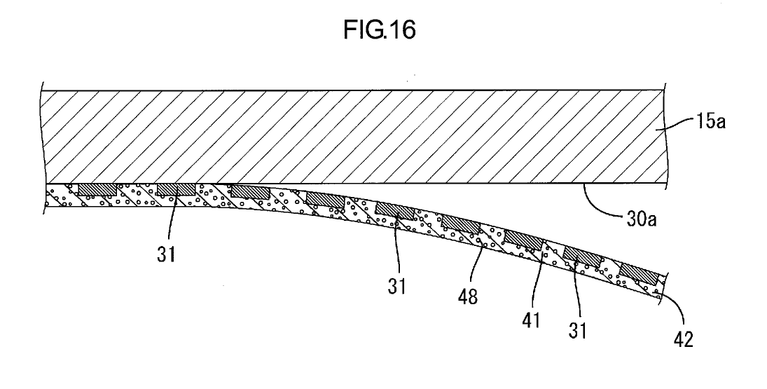

Next, a light reflecting portion formed on a light guide plate according to a fifth modification will be explained with reference to FIG. 16. In the fifth modification, as illustrated in FIG. 16, a functional layer 42 is provided on the first surface 30a of the light guide plate 15a facing the cold cathode tubes 17. The functional layer 42 includes a light reflecting portion 31 that forms a white dot pattern and a charge restricting portion (charge restricting layer) 41 that is provided on the light guide plate 15a closer to the cold cathode tubes 17 than the light reflecting portion 31 and restricts the light guide plate 15a from being charged. A functional sheet is prepared by providing the light reflecting portion 31 on a sheet member including a charge restricting material 48 thereon or therein (thereon and therein in the present embodiment). The functional sheet is adhered to the light guide plate 15a by thermal welding such that the light reflecting portion 31 face the light guide plate 15a to obtain the functional layer 42. A thickness of the light guide plate 15a is approximately 1 mm to 2 mm, and a thickness of the functional layer 42 is approximately 50 μm to 100 μm.

The dot pattern of the light reflecting portion 31 has a configuration similar to that in the above embodiment. The light reflecting portion 31 is configured by a plurality of square dots. Inorganic beads each having a diameter of approximately several hundreds μm are dispersed in each dot and each dot has a surface in white color that provides high light reflectance. The light reflecting portion 31c is formed on the first surface 30a of the light guide plate 15a such that the light reflectance changes in a direction (the X-axis direction) crossing the arrangement direction (the Y-axis direction) of the cold cathode tubes 17. The area of each dot continuously reduces from the end to the middle portion in the longitudinal direction (the X-axis direction) of the light guide plate 15a. Namely, the light reflectance continuously changes in the longitudinal direction of the light guide plate 15a having a rectangular shape with plan view (see FIG. 8). The light reflectance is maximum at the ends (the point A and the point A′) of the light guide plate 15a and minimum at the middle portion (the point B) of the light guide plate 15a. The light reflecting portion 31c is formed such that the light reflectance is uniform in the arrangement direction (the Y-axis direction) of the cold cathode tubes 17. Namely, the light reflectance distribution is substantially uniform in the Y-axis direction on the light guide plate 15a.

Examples of the charge restricting material 48 include materials including surface active agent such as compounds represented by R1R2R3N═O (each of R1, R2, R3 is alkyl group). Specific examples are Aromox DM14D-N, Aromox DMC-W, Aromox DM12D-W, and Aagaard T-28 manufactured by Lion Corporation.

According to the fifth modification, the charge restricting portion 41 provided closer to the cold cathode tubes 17 than the light reflecting portion 31 restricts the light guide plate 15a from being charged regardless of a material used for the light reflecting portion 31. Therefore, dust is not adhered to the light guide plate 15a by static electricity. Other component is not adhered to the light guide plate 15a by static electricity and therefore wrinkle or distortion are not caused between the components. Any material can be used for the light reflecting portion 31 to restrict the light guide plate 15a from being charged and solve the above problems due to static electricity. This increases variety of materials that can be used for the light reflecting portion 31.

### Sixth Modification

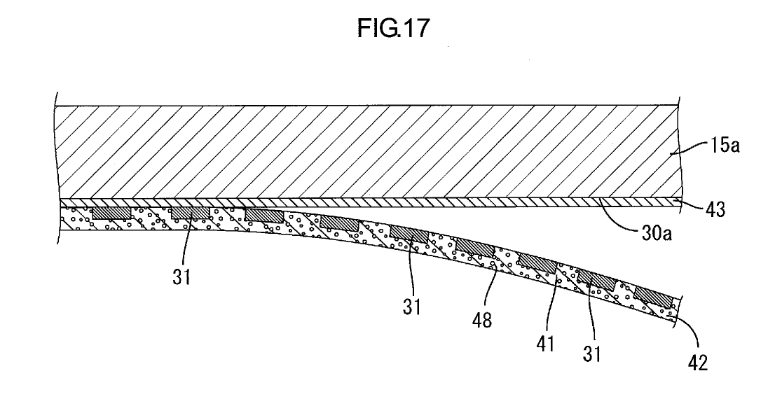

A light reflecting portion formed on a light guide plate according to a sixth modification will be explained with reference to FIG. 17. In the sixth modification, as illustrated in FIG. 17, the functional layer 42 similar to the fifth modification is formed on the first surface 30a of the light guide plate 15a facing the cold cathode tubes 17. An adhesive layer 43 is provided between the light guide plate 15a and the functional layer 42 to adhere them each other. An adhesive of epoxy resin system is used for the adhesive layer 43. With the adhering with such an adhesive layer, the light guide plate 15a provided with the functional layer 42 having light reflecting function and charge restricting function is provided.

### Seventh Modification

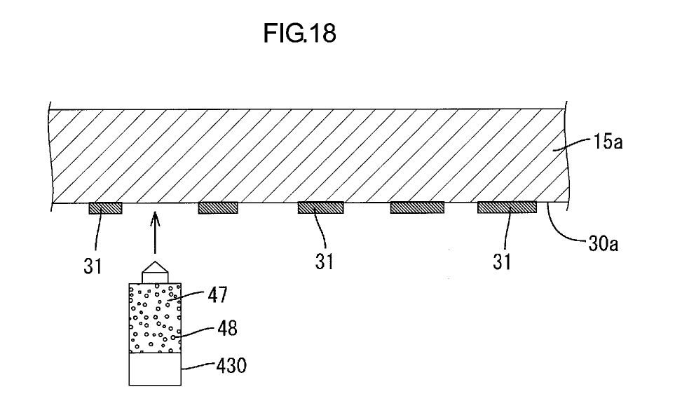

Next, a light reflecting portion formed on a light guide plate according to a seventh modification will be explained with reference to FIG. 18. In the seventh modification, the functional layer 42 similar to the fifth modification is formed on the first surface 30a of the light guide plate 15a facing the cold cathode tubes 17. As illustrated in FIG. 18, after the light reflecting portion 31 is formed on the light guide plate 15a, a resin material 47 containing a charge restricting material 48 is coated over a surface of the light guide plate 15a having the light reflecting portion 31 thereon. Accordingly, the functional layer 42 having the light reflecting function and the charge restricting function is provided on the light guide plate 15a. The resin material 47 is coated by a dispenser 430. However, it may be coated by an ink jet method or a spin coating method. With such coating methods, the light guide plate 15a provided with the functional layer 42 having the light reflecting function and the charge restricting function is provided.

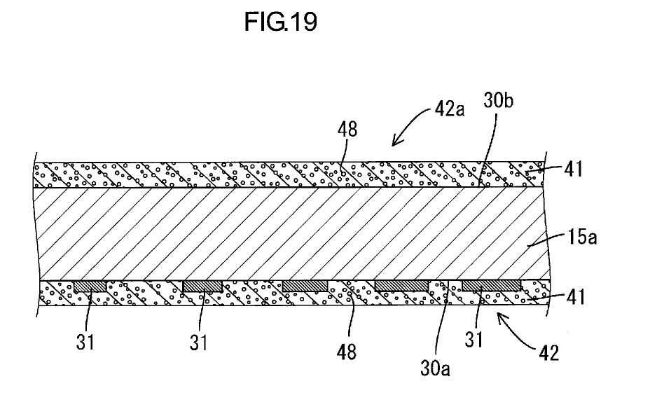

Next, a light reflecting portion formed on a light guide plate according to an eighth modification will be explained with reference to FIG. 19. In the eighth modification, as illustrated in FIG. 19, the functional layer 42 similar to the fifth modification is formed on the first surface 30a of the light guide plate 15a facing the cold cathode tubes 17 and a second functional layer 42a is formed on a surface of the light guide plate 15a close to the liquid crystal panel 11. The second functional layer 42a is formed of the charge restricting portion (charge restricting layer) 41 containing the charge restricting particles 48. Providing the charge restricting portions 41, 41 on front and rear surfaces of the light guide plate 15a reliably ensures the charge restricting function.

### Ninth Modification

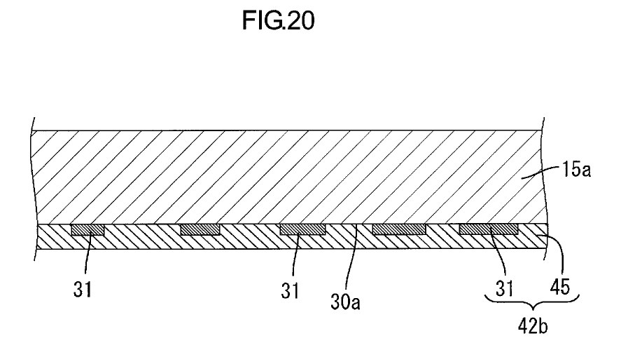

Next, a light reflecting portion formed on a light guide plate according to a ninth modification will be explained with reference to FIG. 20. In the ninth modification, as illustrated in FIG. 20, a functional layer 42b having the light reflecting function and an ultraviolet light restricting function is formed on a surface of the light guide plate 15a close to the cold cathode tubes 17. The functional layer 42b includes the light reflecting portion 31 and an ultraviolet light absorbing portion (ultraviolet light absorbing layer) 45 that is formed on the surface of the light guide plate 15a closer to the cold cathode tubes 17 than the light reflecting portion 31. The ultraviolet light absorbing portion 45 includes an ultraviolet light absorbing material and examples of the ultraviolet light absorbing material include an ultraviolet light absorbing material of triazine series such as 4,6-diphenyl-2-(4-hexyloxy-2-hydroxyphenyl)-s-triazine and an ultraviolet light absorbing material of benzotriazole series such as 2-(2-hydroxy-5-t-octylphenyl)-2-H-benzotriazole.

According to the ninth modification, the ultraviolet light absorbing portion 45 is provided on a surface of the light guide plate 15a closer to the cold cathode tubes 17 than the light reflecting portion 31. Therefore, ultraviolet light is less likely to be transmitted through the light guide plate 15a regardless of the material used for the light reflecting portion 31. Therefore, the components that are provided closer to the light exit side than the light guide plate 15a (the light reflecting portion 31, the optical sheet 15b and the liquid crystal panel 11) are not deteriorated by ultraviolet light. Especially, discoloring or deteriorating of the light reflecting portion 31 due to the ultraviolet light does not occur and the initial product quality is not deteriorated with time. The ultraviolet light absorbing material is included on a surface of the sheet member or in the sheet member to obtain the functional sheet. The functional sheet is adhered to the light guide plate 15a such that the light reflecting portion 31 faces the light guide plate 15a to obtain the functional layer 42b of the ninth modification. After the light reflecting portion 31 is formed on the light guide plate 15a, the resin material containing the ultraviolet light absorbing material may be coated over a surface of the light guide plate 15a having the light reflecting portion 31 to obtain the functional layer 42b.

### Tenth Modification

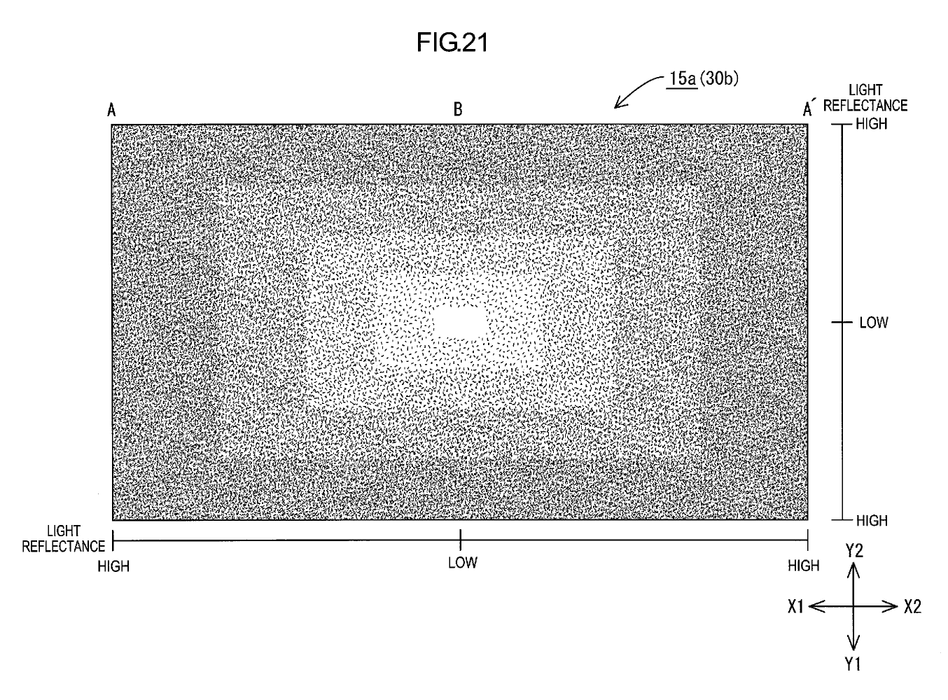

Next, a light reflecting portion formed on a light guide plate according to a tenth modification will be explained with reference to FIG. 21. In the tenth modification, as illustrated in FIG. 21, the light reflecting portion 31 is formed such that the light reflectance changes also in the arrangement direction of the cold cathode tubes 17 (the Y-axis direction). The light reflectance is relatively high at the ends of the light guide plate 15a in the arrangement direction of the cold cathode tubes 17, and the light reflectance is relatively low in the middle portion in the arrangement direction of the cold cathode tubes 17. This further improves brightness in the middle portion.

### Eleventh Modification

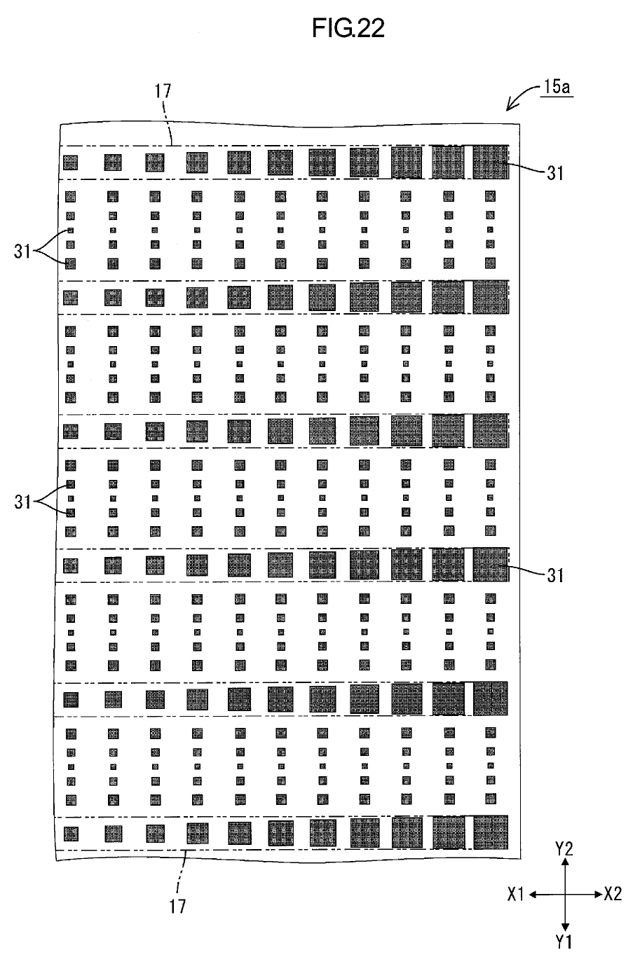

Next, a light reflecting portion formed on a light guide plate according to an eleventh modification will be explained with reference to FIG. 22. In the eleventh modification, as illustrated in FIG. 22, the light reflecting portion 31 is formed such that the light reflectance changes also in the arrangement direction of the cod cathode tubes 17 (the Y-axis direction). The light reflectance is relatively high in portions overlapping the cold cathode tubes 17 and the light reflectance is relatively low in portions that do not overlap the cold cathode tubes 17. The light reflectance is high in the portions overlapping the cold cathode tubes 17 and the light reflectance is low in the portions that do not overlap the cold cathode tubes 17. This solves problems that images of the light sources are recognized.

### OTHER EMBODIMENTS

The embodiments of the present invention have been described, however, the present invention is not limited to the above embodiments explained in the above description and the drawings. The following embodiments may be included in the technical scope of the present invention, for example.

(1) In the above embodiments, each dot of the dot pattern that forms the light reflecting portion and the light scattering portion is formed in a square. However, the shape of each dot is not limited thereto but may be any shape such as a circle or a polygonal shape.

(2) In the above embodiments, the two diffuser sheets are layered as the optical sheets. Any combinations of a diffuser sheet, a lens sheet, a reflective polarizing plate and the like may be used as the optical sheet.

(3) In the above embodiments, the cold cathode tubes are used as the light sources. Other light source such as a hot cathode tube, an LED and the like may be used as the light source.

1. A lighting device comprising:
light sources that are arranged parallel to each other in an arrangement direction with having a small interval between some adjacent light sources and having a large interval between some other adjacent light sources;
a chassis configured to house the light sources therein and having an opening through which light emitted from the light sources exits;
an optical member provided so as to face the light sources and cover the opening; and
a light reflecting portion provided on the optical member and configured to reflect light emitted from the light sources and change light reflectance in a direction crossing the arrangement direction of the light sources.

2. The lighting device according to claim 1, wherein the light sources are arranged in an installation area and the light sources are arranged such that an interval between adjacent light sources is relatively large at ends of a light source installation area in the arrangement direction of the light sources and the interval between adjacent light sources is relatively small in a middle portion of the installation area in the arrangement direction.

3. The lighting device according to claim 1, wherein the light reflecting portion is provided such that light reflectance is relatively high at ends in a direction crossing the arrangement direction and light reflectance is relatively low in a middle portion in the direction crossing the arrangement direction.

4. The lighting device according to claim 1, wherein:
the optical member is formed in a rectangular shape;
the light sources are arranged in the arrangement direction along one side of the rectangular optical member; and
the light reflecting portion is formed such that light reflectance changes in a direction along another side of the rectangular optical member that crosses the one side.

5. The lighting device according to claim 1, wherein:
the optical member is formed in a rectangular shape with plan view;
the light sources are configured by elongated linear light sources, each axial line of the light sources matches a long side of the optical member, the light sources are arranged in the arrangement direction along a short side of the optical member, and the light sources are arranged to have a relatively large interval between adjacent light sources at ends in a direction along the short side of the optical member and have a relatively small interval between adjacent light sources in a middle portion in a direction along the short side of the optical member; and
the light reflecting portion is provided to have relatively high light reflectance at ends in a direction along the long side of the optical member and have relatively low light reflectance in a middle portion in a direction along the long side of the optical member.

6. The lighting device according to claim 1, wherein the light reflecting portion is provided to have uniform light reflectance in the arrangement direction of the light sources.

7. The lighting device according to claim 1, wherein:
the light reflecting portion is provided such that light reflectance changes also in the arrangement direction of the light sources; and
light reflectance is relatively high at ends of the optical member in the arrangement direction of the light sources and light reflectance is relatively low in a middle portion of the optical member in the arrangement direction of the light sources.

8. The lighting device according to claim 1, wherein:
the optical member is provided such that light reflectance changes also in the arrangement direction of the light sources; and
light reflectance is relatively high in a portion of the optical member that overlaps the light source and light reflectance is relatively low in a portion of the optical member that does not overlap the light source.

9. The lighting device according to claim 1, wherein the light reflecting portion is configured by a dot pattern having light reflectivity.

10. The lighting device according to claim 9, wherein the dot pattern forming the light reflecting portion is configured such that a number of dots of the dot pattern in a unit area reduces from a portion having high light reflectance to a portion having low light reflectance.

11. The lighting device according to claim 1, wherein the light reflectance reduces in a continuous and gradual manner from a portion having high light reflectance to a portion having low light reflectance.

12. The lighting device according to claim 1, wherein the light reflectance reduces in a stepwise and gradual manner from a portion having high light reflectance to a portion having low light reflectance.

13. The lighting device according to claim 1, further comprising:
a functional layer provided on a side of the optical member close to the light sources and configured to provide a certain function to the optical member, wherein:
the functional layer includes the light reflecting portion and a charge restricting portion that is provided closer to the light sources than the light reflecting portion and configured to restrict the optical member from being charged.

14. The lighting device according to claim 13, wherein the functional layer is formed by providing the light reflecting portion on a sheet including a charge restricting material thereon or therein to obtain a functional sheet and adhering the functional sheet to the optical member such that the light reflecting portion faces the optical member.

15. The lighting device according to claim 13, wherein the functional layer is formed by providing the light reflecting portion on the optical member and coating a surface of the optical member including the reflecting portion with a resin material including a charge restricting material.

16. The lighting device according to claim 1, further comprising:
a functional layer provided on a light source side of the optical member and configured to provide a certain function to the optical member, wherein:
the functional layer includes the light reflecting portion and a ultraviolet light absorbing portion that is provided closer to the light sources than the light reflecting portion and configured to absorb ultraviolet light.

17. The lighting device according to claim 16, wherein the functional layer is formed by providing the light reflecting portion on a sheet including an ultraviolet light absorbing material thereon or therein to obtain a functional sheet and adhering the functional sheet to the optical member such that the light reflecting portion faces the optical member.

18. The lighting device according to claim 16, wherein the functional layer is formed by providing the light reflecting portion on the optical member and coating a surface of the optical member including the reflecting portion with a resin material including an ultraviolet light absorbing material.

19. A display device comprising:
the lighting device according to claim 1; and
a display panel configured to provide display using light from the lighting device for a display device.

20. The display device according to claim 19, wherein the display panel is a liquid crystal display panel using liquid crystal.

21. A television receiver comprising the display device according to claim 19.
